(19) United States
(12) Patent Application Publication
(10) Pub. No.: US 2025/0307209 A1
(43) Pub. Date: Oct. 2, 2025

(54) HYBRID FILESYSTEM FOR FLEXIBLE AND HIGH-PERFORMANCE CLOUD GAMING STORAGE

(71) Applicant: Sony Interactive Entertainment Inc., Tokyo (JP)

(72) Inventor: David Coles, San Mateo, CA (US)

(21) Appl. No.: 18/623,895

(22) Filed: Apr. 1, 2024

(51) Int. Cl. G06F 16/11; H04L 67/131

(52) U.S. Cl. CPC G06F 16/128; H04L 67/131

(57) ABSTRACT

Techniques for managing snapshot storage on computer game servers use a hybrid filesystem which combines the best parts of raw disk access and a filesystem. The format is defined so that storage is not limited to the limited feature-set of legacy-but-commonly supported filesystems. Storage “blocks” are allocated in an optimal manner. Because the hybrid filesystem has access to low-level storage information, certain currently impossible features such as storage redundancy or data striping across disks can be implemented. Flexible metadata that can be safely used by multiple systems simultaneously or make live updates to content can be stored without having to shut down one or more systems.

### FIELD

The present application relates generally to cloud gaming storage.

### BACKGROUND

Cloud computer gaming entails extremely demanding storage performance requirements. To address this, gaming servers present storage to datacenter-based consoles that source games to end users as a raw NVMe disk images. However, as understood herein this causes a number of operational headaches. Managing large raw disk images (e.g. a game) is tricky because finding contagious disk space for non-uniform sized disk images becomes increasingly difficult as images are added and removed, leading to “fragmentation” which wastes significant amounts of physical disk space. Further, raw disk images lack metadata about their contents, and moreover are ‘opaque’, preventing many useful optimizations. Still further, raw disk images can't be modified by multiple devices at the same time.

### SUMMARY

Present principles address the above technical challenges by storing disk images in a hybrid disk/filesystem format. This has a number of benefits, including simplifying management of game data by making it is as easy as moving files on a filesystem (including advanced features like snapshotting, de-duplication, RAID and automatic defragmentation). With low-level knowledge of the filesystem efficient and high performance scatter-gather DMA transfers can be performed between hardware components running different environments (e.g. different OSs). Also, with low-level knowledge of the filesystem multiple independent systems can safely interact with the same data without catastrophic data corruption occurring.

Accordingly, in a first aspect a method includes generating, using a computer game streaming server configured for streaming computer game to end user computer game systems, at least one vendor-specific command (VSC). The method includes receiving the VSC at a non-volatile memory express (NVMe) emulator in a storage server. Further, the method includes, responsive to the VSC, generating a snapshot of a computer game being executed in the computer game streaming server, and attendant to generating the snapshot, ensuring all updates to a save data partition to which the snapshot is to be stored have been completed. The method further includes, responsive to the snapshot being successfully completed, sending a notification of success to the computer game streaming server, and responsive to the snapshot not being successfully completed, sending a notification of failure to the computer game streaming server.

In some embodiments the method can include sending from the computer game streaming server to the storage server an indication of a first save data of plural save datas is to be subject of the snapshot. The method may include using the storage server to look up a corresponding partition where the first save data is attached.

In example implementations the method may include, during generating the snapshot, not submitting by the computer game streaming server new operations until a synchronization step has been completed. In so doing the game server may wait for notification of the snapshot operation to complete or forced and the storage server can cooperatively delay processing of storage operations until the snapshot is completed. Both can be implemented so that the game server doesn't hang because it is stuck in the middle of a storage operation but also prevents a misbehaving gaming server from corrupting data.

If desired, the VSC may act as a write barrier, allowing finishing generating the snapshot without any writes to the storage server. The method can include storing the snapshot in cloud storage separate from the storage server and computer game streaming server.

In another aspect, an apparatus includes at least one computer game streaming server configured to stream computer games to end user game systems. The apparatus also includes at least one storage server configured for receiving from the computer game streaming server requests for snapshots of game data. At least one non-volatile memory express (NVMe) emulator is implemented by the storage server and is configured for generating at least one snapshot responsive to a request for a snapshot from the computer game streaming server. Further, at least one manager utility is implemented in the storage server and is configured for uploading the snapshot to a cache storage in the storage server under control of a partition data coordinator command-line tool. (PaDaCo). At least one external cloud storage receives the snapshot from the cache and storing the snapshot.

In another aspect, a device includes at least one computer memory that is not a transitory signal and that in turn includes instructions executable by at least one processor system to create a snapshot of computer game data at a storage server responsive to a request for a snapshot from a computer game streaming server. The instructions are executable to generate a filesystem event by a Linux kernel in the storage server pursuant to the snapshot and receive, in the storage server, an event for a new file being created. In non-limiting embodiments two different signals and corresponding behavior may occur at this point, namely, a vendor specific command (VSC) command to an NVMe emulator to create a new snapshot and a Linux filesystem event (due to the creation of a new file—the snapshot) that is used to notify management software that a new snapshot has been created, which may trigger an operation like asynchronous upload to separate cloud storage. The instructions are executable to, responsive to determining, by the storage server, that the event is a snapshot, upload snapshot data at least in part using meta information including at least title ID and user ID to at least one cloud storage separate from the storage server.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example game streaming architecture;

FIG. 3 illustrates an example information architecture;

FIG. 5 illustrates example VSC logic in example flow chart format;

FIG. 5 illustrates simultaneous reads and writes between storage components;

FIG. 6 illustrates an example cloud storage architecture for computer games;

FIG. 7 illustrates example logic in example flow chart format consistent with FIG. 6;

FIG. 8 illustrates additional example logic in example flow chart format; and

FIG. 9 illustrates example lock logic in example flow chart format.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

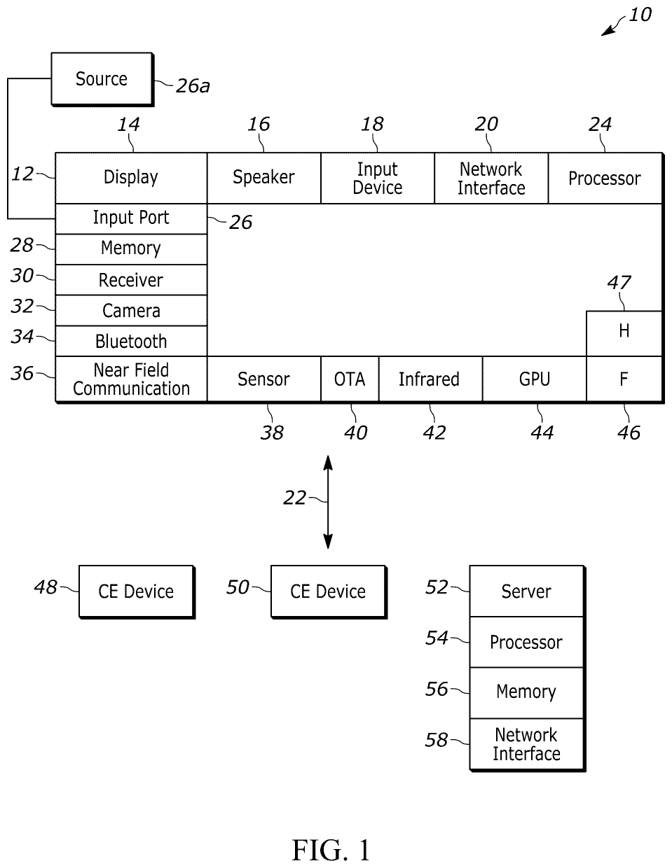

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

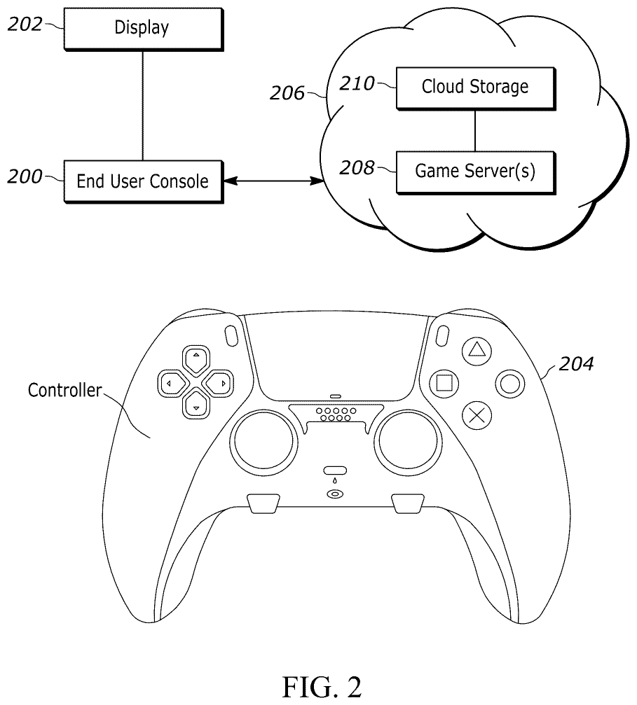

Refer now to FIG. 2. An end user computer simulation console 200 such as a video game console presents computer simulations such as computer games on a display 202 under control of a computer simulation controller 204 such as a game controller. Computer games can be streamed to the end user system from a cloud streaming service 206, which may include one or more game servers 208 and one or more cloud storage systems 210. The game servers 208 may be implemented by computer game consoles which themselves provide game engine information to the end user systems. The gamer servers 208 may be referred to herein as “GKP”, referring to the piece of dedicated hardware in a streaming rack that can run a console game such as a PlayStation 5 console game.

Present principles solve storage challenges in the cloud system 206.

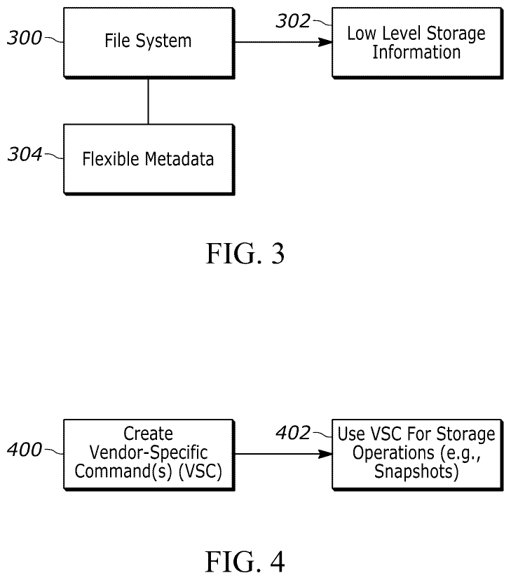

FIG. 3 illustrates a high level overview. A “hybrid filesystem” specification is created as represented by block 300 which combines the best parts of raw disk access and a traditional filesystem. Because the format of the file system 300 is defined, it is not limited to the limited feature-set of legacy-but-commonly supported filesystems. Storage blocks also can be allocated in an optimal manner for the game streaming use-case (e.g., while XFS is limited to 64 KiB blocks, block size in the present system can be variable.) Because the hybrid filesystem has access to low-level storage information 302, certain currently difficult-to-implement features such as storage redundancy or data striping across disks can be implemented. Again, because the hybrid filesystem format is defined for game streaming service, flexible metadata 304 can be stored that can be safely used by multiple systems simultaneously or make live updates to content without having to shut down one or more systems.

It is to be understood that an XFS file system is a Linux file system that can be used as an alternative to more complex file systems. Present techniques use XFS as a way to manage (primarily game) data on the storage server 602 as files rather than raw disk offsets.

The bulk of reads/writes go directly to the underlying NVMe disk(s).

Note that inotify is a Linux-specific API that allows a program to “watch” for filesystem changes (new files, modification, etc.)

Instead of transferring certain data such a language preferences for a user and other data apart from data targeted as bits for storage out-of-band, present principles transfer such data in-band over the storage connection, which efficiency is leveraged to synchronize snapshots back and forth.

Two techniques are introduced. In FIG. 4, state 400 indicates that vendor-specific commands (VSC) are defined and used by all relevant components for storage operations at state 402, including snapshotting of game data. An example VSC is “take a snapshot now; suspend reads and writes until clear”. Another VSC may be for requesting the attachment/detachment of various kinds of storage partitions containing the game data and user data for the session and doing so in a manner that is not out-of-band to avoid suffering from performance bottle-necks and some ordering-of-events challenges such as ensuring detachment of the previous partition is finished before fulfilling the console's request to attach a new partition. This may be referred to as “dynamic mounting”. The game server can request game/user data on demand (e.g. switching users, games, . . . ) rather than being fixed for the entire duration of a session to result in a game streaming service and not just a remote-controlled personal game console. Note that absent present principles, the attach/detach commands are transmitted via “out-of-band” network, but present techniques advantageously facilitate “in-band” requests using a NVMe VSC.

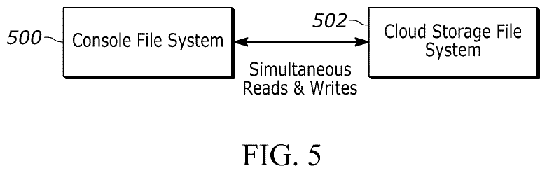

FIG. 5 illustrates a second technique. A console file system such as may be implemented in a server-based streaming console 500 (as may be implemented in the game servers 208 in FIG. 2) exchanges simultaneous reads and writes with the storage system 210 in FIG. 2 using a data structure on both sides that is used to access file-like objects while handling the two systems reading and writing at the same time, making sure not to corrupt data between the two.

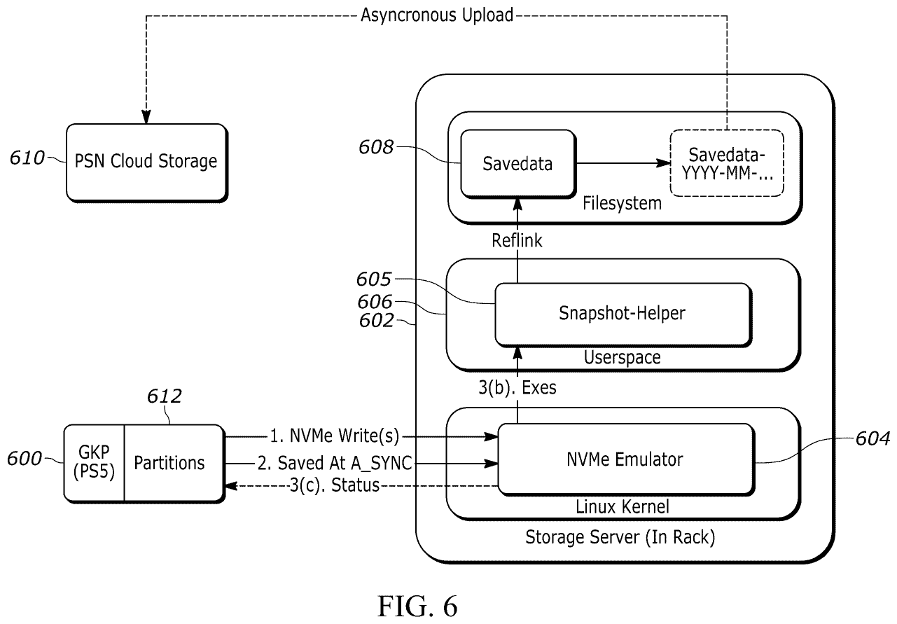

Refer now to FIG. 6. Snapshots of save data avoid the situation that an application cannot update save data while it is being uploaded. The creation of a snapshot is triggered by a GKP 600 of a server system by sending a NVMe Vendor Specific Command (VSC) to a per-rack storage server 602 which can fill the role of supervising all the GKP in the streaming rack. An NVMe emulator 604 in the storage server 602, which may be executed by a Linux kernel, uses this event to create a snapshot. More specifically, the NVMe emulator 604 may be implemented as a Linux kernel module that acts as both an “emulator” of NVMe operations and a driver for the custom hardware required to allow high-speed PCIe communication (including NVMe operations) between the GKP and the storage server. Thus, the emulator 604 may sometimes be referred to herein as a “driver”.

After the snapshot is created, a mount-manager utility 605 (labeled “snapshot helper” in FIG. 6) that is implemented in a user space 606 of the storage server 602 is responsible for uploading the snapshot to a cluster 608 of bulk per-datacenter storage under control of a service associated with a partition data coordinator (PaDaCo). The PaDaCo service understands what “user data” is and decides where and when to put it in the cluster 608. Together, the cluster 608 and PaDaCo act as a cache layer for external system (e.g., PlayStation or PSN) cloud storage 610. The cluster 608 may be considered to be a save data partition stored as a raw image file on the storage server's XFS filesystem. A partition (containing a single filesystem) is the smallest granularity for operating at. A partition may be a read-only game package, a read-write save data image, or a common “lingua-franca” filesystem for providing a collection of loose files (e.g. configuration, game metadata, etc.).

A rack manager utility portion, of which the above-mentioned mount manager 605 is a component, manages the lifecycle of any resources (e.g. GKP) in a Cloud Gaming rack so that a specific game with user data available may be streamed to an end user console. The rack manager is indirectly involved with making snapshots, executing the upload to the system cloud storage 610. The mount manager is the component of the rack manager to which the GKPs 600 request to attach/detach game or user data partitions 612 (the aforementioned “dynamic mounting”).

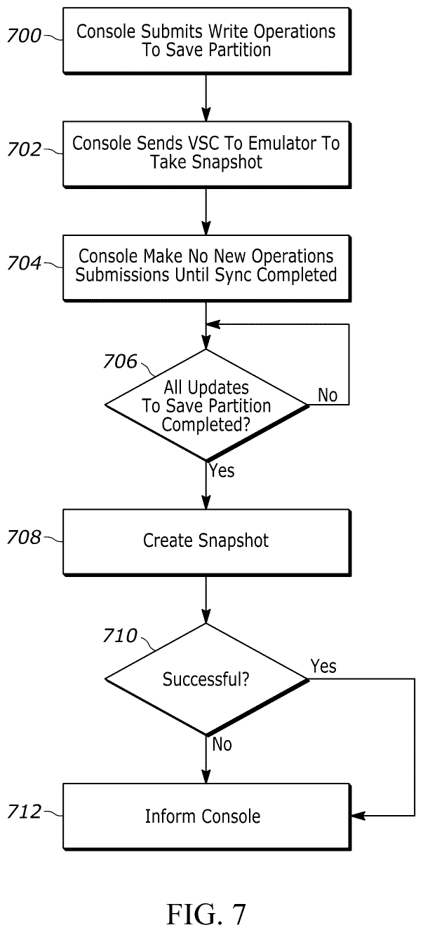

FIG. 7 illustrates the technique facilitated by FIG. 6 from the GKP and NVMe emulator perspective. At state 700, the GKP submits write operations to the cluster 608 shown in FIG. 6 State 702 indicates that the console (GKP) sends a VSC to the NVMe emulator 604 to take s snapshot.

Note that in some embodiments, a computer game running on the GKP 600 can have plural “save data” open simultaneously. When the GKP requests that the storage server 602 take a snapshot using the VSC, it may include the number of which of the plural save datas it wants the storage server 602 to take a snapshot of. However, the storage server 602 must first look up the corresponding partition where the specified save data is attached.

State 704 indicates that during the process at the emulator, the GKP does not submit any new operations until a synchronization step has been completed.

State 706 indicates that when the NVMe emulator makes sure all updates to the save data partition have been completed (during which time GKP will not submit new operations till savedata sync has been completed), the logic moves to state 708 in which the NVMe emulator creates a snapshot. If a snapshot has been determined to be successful at state 710, at state 712 the emulator returns notification of success to the GKP, and otherwise returns a notification of failure to the GKP at state 712.

The SAVEDATA_SYNC NVMe Vendor Specific Command at state 702 thus acts as a write barrier, allowing the NVMe emulator to finish any outstanding operations. When all outstanding operations before the SAVEDATA_SYNC NVMe VSC have been processed, then it is safe for a snapshot to be created. Any operations that are received after the SAVEDATA_SYNC NVMe VSC are blocked (queued) until the snapshot operation has completed. In detailed implementation of a non-limiting embodiment, only (queue) requests made to the specific partition for which the snapshot was requested may be subject to blocking. Otherwise issuing a snapshot for save data might interfere with operations for other partitions.

In an example embodiment, the in-kernel NVMe emulator 604 shown in FIG. 6 may trigger creation of a snapshot using a usermode helper hook that runs a script as shown below (which is called by the NVMe emulator 604) to perform the actual snapshot creation. In the code below, a copy-on-write reflink feature allows dramatic reduction in space requirements for game titles, etc. by sharing blocks between game patches:

#!/bin/bash
# Create a timestamp-appended snapshot of a file
# with the format ‘FILENAME-YYYY-MM-DDTHH:MM:SS.NNNZ‘
#
# Usage: cronos-snapshot-helper FILENAME
timestamp=″$(date +%Y-%m-%dT%H:%M:%S.%3NZ)″
cp --reflink ″$1″{,:″${timestamp}″}

In example implementations, efficient snapshots can be created using “reflinks” (via the ioctl_ficlonerange system call), a feature which allows a fast “copy-on-write” sharing of physical disk blocks among several files. This can be done almost instantaneously because it only requires incrementing the reference count to the existing blocks on disk rather than having to make a full bit-for-bit copy of the file contents. The use of “reflinks” facilitates efficient storage of multiple revisions of a game on the storage server. By using “reflinks” an earlier version of a game title (e.g. 1.0) can be patched with just the changes between the two versions (e.g. 1.0→1.3), so that the two versions of the game package share the common unchanged data. This can have a significant impact on storage costs because it avoids storage of a full (˜100 GB) copy of each patch of the game. This high performance, low latency storage is already very expensive. Use of reflinks also speeds up distribution of updates as only the “delta” change is required. Moreover, the game packages can be used “as is”, because it means a custom efficient image distribution system is not needed.

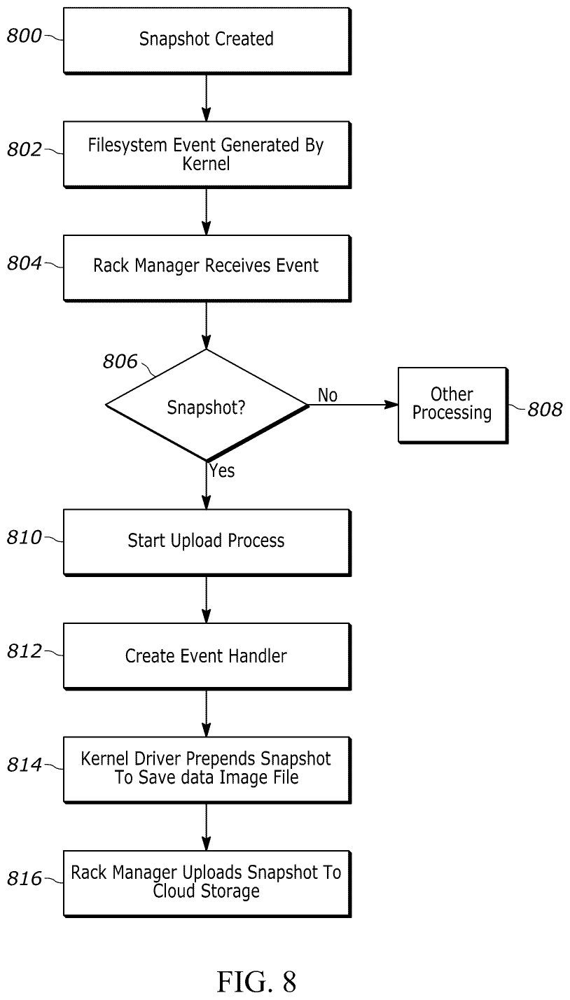

The rack manager of the user space 606 in FIG. 6 learns about the creation of a new snapshot file by monitoring changes to the filesystem using inotify. Every time a new snapshot is created, the rack manager can make it ready for being uploaded. FIG. 8 illustrates.

Commencing at state 800, a snapshot is created and at state 802 a filesystem event is generated by the Linux kernel in the storage server 602.

Moving to state 804, the rack manager in the user space 606 receives an event for a new file being created using inotify in example embodiments. Proceeding to state 806, it is determined by, e.g., the rack manager if the event is a snapshot. If not, other processing for non-snapshot events may be implemented at state 808, but if the event is a snapshot, the logic moves to state 810 to start the process for uploading snapshot data using the correct meta information (title id, user id, etc.).

Moving to state 812, an event handler is created, e.g., by the rack manager, using for example an inotify event handler loop per session that is created on session start and destroyed on session end. Code below illustrates an example inotify rust wrapper, which is a software library for the Rust Programming Language to allow it to call the inotify application programming interface (API):

```
  https://crates.io/crates/inotifyNVMe emulator calling the user mode
  helper scriptr
prepends snapshot_ to the savedata image file and appends a timestamp
(state 814 in Figure 8).
For example:
  nemralino@cronos-ws-07
  /srv/cronos/users/0x259f6ca657b4241b/roaming/PPSL03616 $ tree .
  [root 91] .
```

| | |
|---|---|
| \| | _{——}[root 20971520] sdimg_SaveDataTest |
| \| | _{——}[root 20971520] |

snapshot_sdimg_SaveDataTest_2022-11-30_01-06-00-867

Note that the snapshot operation does not complete until the usermode helper script exits. This ensures that there isn't a “race condition” in which the NVMe emulator 604 resumes processing NVMe operations before the snapshot is actually created. The usermode helper also has a clearly defined start and stop (when the script process starts and when it exits). This means that an invalid state is avoided in which the NVMe emulator 604 is waiting for a “finished” signal, but the userspace doesn't know that the NVMe emulator is waiting.

In a non-limiting embodiment, the rack manager can use a combination of inotify (EventMask::CREATE) and regex to determine that a snapshot was created, and for which file. The rack manager can then issue a PaDaCo client command to upload the snapshot file to the cloud storage 610 at state 816 in FIG. 8.

In the explanation above, “regex” means “regular expression” which describes patterns. More specifically, when the snapshot helper 605 shown in FIG. 6 creates a “snapshot” (a copy at a specific state in time) of a file, the new snapshot file can be given a date/time-based suffix (e.g. “savadata”→“savedata:2024-03-11T16:16:34.142Z”). When the rack manager sees that a new file has been created, it checks that the file matches the “pattern” of a snapshot and pulls apart the filename into each of the date and time pieces. A “regex” describes these patterns in a concise if difficult to read manner:
\hat{ }(·*)(:[0-9]{4}-[0-9]{2}-[0-9]{2}T[0-9]{2}:[0-9]{2}:[0-9]{2}·[0-9]{3}Z)$

There can be multiple concurrent snapshots created (for different savedata partitions) per session. As understood herein, uploading the multiple snapshots sequentially within the event handler thread may result in missing another event or prevent upload it in a timely manner if the current upload snapshot is large. To address this, a thread pool may be created specifically for uploading to cloud storage 610. Use of a thread pool enables limiting the number of threads being created. As used herein, a “thread” is a single flow of computer instructions and state. Computer programs start out with just one main thread, but can create more so they can do several things at the same time (the program is now “multi-threaded”). One major use is to offload tasks that involve a lot of waiting so the main thread of the program isn't blocked and can keep doing work. Threads take a little bit of resources to create, so a “pool” of threads can be created in advance and reused rather than creating a new one every time.

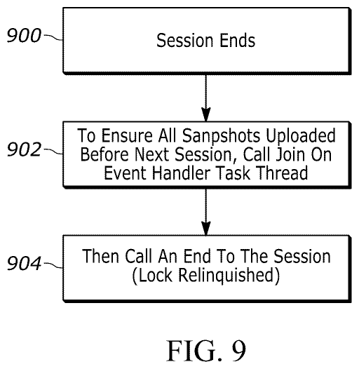

FIG. 9 illustrates that when a snapshot session ends at state 900, to ensure that all snapshots have finished uploading before the next session is started, at state 902 the rack manager may call join on the inotify event handler task/thread (and upload the thread pool has been shutdown) before calling an end of session at state 904. An end of session may be called using a padaco-cli PUT for the user's profile and save data. This ensures that snapshots are uploaded at the end of the session before a lock providing exclusive access to this user data is relinquished for the user's next session.

In greater detail with respect to FIG. 9, at the end of a game streaming “session”, the rack manager in the user space 606 of FIG. 6 needs to wait (“join”) for all the mid-session snapshots threads to finish uploading (using the “PUT” command of the padaco-cli tool in a non-limiting implementation) to the cloud storage 610 before performing a final end-of-session upload of the common non-game specific user data (e.gthe user's profile and save data). If the rack manager continued past this point, then it would let go of exclusive ownership of the exclusive lock on a user's data and that user could start playing a game on another rack before all of his user/save data was up to date in the cloud storage 610. This means that the user might not see the in-game progress made by the user during the first session, or cause there to be a conflict deciding which bit of save data is the most up-to-date “current” one.

The GKP sees the Storage Server as a very large virtual disk drive subdivided into 256 partitions. This allows us to independently attach/detach different pieces of user data/save data/game data from the GKP while it is still running.

In example embodiments, a tight dependency between the driver embodied by the NVMe emulator 604 in FIG. 6 and rack manager (or mount manager) in the user space 606 should be avoided. inotify can be used as a way to make the mount manager in the user space 606 aware of new snapshots without an explicit dependency upon the driver. When making a snapshot, all input-output to the affected partition is temporarily blocked. However, since creating reflinks is fast it should not I/O for too long.

It may now be appreciated that absent present techniques, snapshots of game state are configured by hardcoding the mapping in the driver. The input of the map is a savedata partition id and the output is the specific partition in a partition table that is associated with it. The issue with this approach is twofold. First, any change to the partition table requires rolling out a new version of the driver. Second, business logic lives within the partition backend of the driver. Accordingly, present techniques make partitions configurable through configfs if they support snapshots or not by setting a snapshot id that matches what the VCS would provide to create a snapshot. It is to be understood that the NVMe emulator 604 supports having partitions in several different configurations (for example, backed by an on-disk filesystem, backed by an in-memory filesystem, read-write, read-only, snapshots enabled, snapshots disabled, etc.). Snapshots are only used for user data (like game saves), while game data is read-only so multiple rack game servers 600 can use the same game image file at the same time.

While the particular embodiments are herein shown and described in detail, it is to be understood that the subject matter which is encompassed by the present invention is limited only by the claims.

What is claimed is:

1. A method comprising:
generating, using a computer game streaming server configured for streaming computer game to end user computer game systems, at least one vendor-specific command (VSC);
receiving the VSC at a non-volatile memory express (NVMe) emulator in a storage server;
responsive to the VSC, generating a snapshot of a computer game being executed in the computer game streaming server;
attendant to generating the snapshot, ensuring all updates to a save data partition to which the snapshot is to be stored have been completed;
responsive to the snapshot being successfully completed, sending a notification of success to the computer game streaming server; and
responsive to the snapshot not being successfully completed, sending a notification of failure to the computer game streaming server.

2. The method of claim 1, comprising sending from the computer game streaming server to the storage server an indication of a first save data of plural save datas is to be subject of the snapshot.

3. The method of claim 2, comprising using the storage server to look up a corresponding partition where the first save data is attached.

4. The method of claim 1, comprising, during generating the snapshot, not submitting by the computer game streaming server new operations until a synchronization step has been completed.

5. The method of claim 1, wherein the VSC acts as a write barrier, allowing finishing generating the snapshot without any writes to the storage server.

6. The method of claim 1, comprising storing the snapshot in cloud storage separate from the storage server and computer game streaming server.

7. An apparatus comprising:
at least one computer game streaming server configured to stream computer games to end user game systems;
at least one storage server configured for receiving from the computer game streaming server requests for snapshots of game data;
at least one non-volatile memory express (NVMe) emulator implemented by the storage server and configured for generating at least one snapshot responsive to a request for a snapshot from the computer game streaming server;
at least one manager utility implemented in a user space of the storage server and configured for uploading the snapshot to a cache storage in the storage server under control of a partition data coordinator (PaDaCo); and
at least one external cloud storage receiving the snapshot from the cache and storing the snapshot.

8. The apparatus of claim 7, wherein the cache comprises a cluster of bulk per-datacenter storage.

9. The apparatus of claim 7, wherein the PaDaCo is configured to identify what user data is and decide where and when to store the user data in the cache.

10. The apparatus of claim 7, Wherein the manager utility comprises a rack manager utility portion comprising a mount manager and configured to manage a lifecycle of any resources in a cloud gaming rack so that a specific game with user data available may be streamed to an end user computer game system.

11. The apparatus of claim 10, wherein the rack manager is configured to request to attach/detach game or user data partitions.

12. The apparatus of claim 7, wherein the requests for a snapshot comprises vendor-specific commands (VSC).

13. A device comprising:
at least one computer memory that is not a transitory signal and that includes instructions executable by at least one processor system to:
create a snapshot of computer game data at a storage server responsive to a request for a snapshot from a computer game streaming server;
generate a filesystem event by a Linux kernel in the storage server pursuant to the snapshot;
receive, in the storage server, an event for a new file being created; and
responsive to determining, by the storage server, that the event is a snapshot, upload snapshot data at least in part using meta information comprising at least title ID and user ID to at least one cloud storage separate from the storage server.

14. The device of claim 13, wherein the instructions are executable to:
create an event handler using a manager in the storage server.

15. The device of claim 14, wherein the event handler comprises an inotify event handler loop per session that is created on session start and destroyed on session end.

16. The device of claim 13, wherein the request for a snapshot comprises a vendor-specific command (VSC).

17. The device of claim 13, wherein the event is signaled using inotify.

18. The device of claim 13, wherein determining whether the event is a snapshot is executed by a rack manager of the storage server.
